(19) United States
(12) Patent Application Publication
(10) Pub. No.: US 2009/0226558 A1
(43) Pub. Date: Sep. 10, 2009

(54) ORGANIC/NATURAL POULTRY FEED ADDITIVE

(75) Inventors: John H. Cheek, Blairsville, GA (US); John J. Roberts, Blairsville, GA (US)

Correspondence Address: Pabst Patent Group LLP, 1545 PEACHTREE STREET NE, SUITE 320, ATLANTA, GA, 30309, US

(73) Assignee: C & R BIOTEK, LLC

(21) Appl. No.: 12/363,097

(22) Filed: Jan. 30, 2009

Related U.S. Application Data
(60) Provisional application No. 61/063,062, filed on Jan. 31, 2008.

(51) Int. Cl. A23K 1/18; A23J 1/00

(52) U.S. Cl. 426/2; 426/656

(57) ABSTRACT

An animal feed additive product is based on a combination of four natural ingredients, propolis, ginger root, colostrums, and L-lysine, each of which has properties either effective against specific pathogens or which is known to be an immune system stimulant/enhancer. These components are currently in use individually in many animal and human health-related products. The initial formulations used in preliminary research described in the example used equal parts by weight of prepared, powdered ingredients. Formulations can be modified as needed to fit the needs of different poultry product applications. The research results showed a statistically significant increase in egg yield, weight gain and feed conversion efficiency. Although not significantly significant at the generally accepted 0.05 level, evidence of immune system stimulation showed a positive trend, increasing with additive strength increase.

### CLAIM TO PRIORITY

This application claims priority to U.S. Ser. No. 61/063,062 filed Jan. 31, 2008.

### FIELD OF THE INVENTION

This invention is generally in the field of organic or natural feeds providing increased yields or decreased incidence of disease in poultry or other animals.

### BACKGROUND OF THE INVENTION

Feeding chickens is relatively simple. On the most basic level, all one has to do is go to a local feed store and grab a bag of chicken feed formulated for the age group and type of chicken. There are specific commercial feed formulations for layers, meat birds (broilers), chicks, growers, show birds, etc. For meat birds, 100 4-week old meat birds should eat no less than about 7-8 pounds of chicken feed/day. The amount of feed for hens, on the other hand, depends on their size and breed and the rate of their lay. Generally, small layers like Leghorns will eat about 4-5 ounces of feed per day. Larger breeds, like Barred Plymouth Rocks, eat a little more. Besides feed and water a calcium supplement (if they are layers) is required, such as oyster shell. Because all birds lack teeth, grit helps the chickens digest their food.

Most commercially available poultry feeds contain many of the same ingredients, as follows.

Proteins: In poultry, the products produced consist mainly of protein. On a dry weight basis the carcass of an 8 weeks old broiler is more than 65% protein and the egg contents are about 50% protein. Typical broiler rations will contain from 22 to 24% protein and in layers ration the amount varies between 16-17%. Sources: Meat scraps (lysine), fish meal (lysine, methionine), poultry by-product meal (tryptophan, lysine), blood meal, liver and glandular meal, feather meal (hydrolyzed), animal tankage, milk products, cottonseed meal, peanut meal, soybean meal, sesame meal, sunflower seed meal.

Carbohydrates: The main function of carbohydrates in the diet is to provide energy to the animal. The polysaccharides of major importance are starch, cellulose, pentosans and several other complex carbohydrates. Although cellulose and starch are composed of glucose units, chickens possess enzymes that can hydrolyze only starch. Cereal grains and their by-products are excellent sources of starch and thus constitute a bulk of poultry ration. Sources: Corn, sorghum grains (milo) barley, rye, oats, wheat, wheat middlings, various grain by-products.

Fats: Fats make up over 40% of the dry egg and about 17% of the dry weight of a broiler. Most feed ingredients (maize, barley, safflower, milo, wheat, rice, bran, etc.) contain 2-5% fat and linoleic acid, which must be present in the young growing chicks or they will grow poorly, have an accumulation of liver fat and be more susceptible for respiratory infection. Laying hens with diets deficient in linoleic acid will lay small eggs that will not hatch well. Sources: Animal tallow (beef), lard, corn-oil, other vegetable oils.

Minerals: The body of the chicken and the egg excluding shell contain nearly 4 and 1% mineral matter respectively. The elements known to be required in the diet of poultry are calcium, phosphorus, sodium, potassium, magnesium, chlorine, iodine, iron, manganese, copper, molybdenum, zinc and selenium. Common mineral supplements in poultry feed are: Limestone, Bone meal, Oyster shell, Sodium chloride, Dicalcium phosphate, Manganese sulphate, Potassium iodide, and Superphosphate. Sources: Meat scraps, fish meal, milk products, ground limestone (calcium), ground oyster shells (calcium), dicalcium phosphate (calcium, phosphorus), defluorinated rock phosphate (phosphorus, calcium), steamed bone meal (phosphorus, calcium), salt (sodium, chlorine, iodine), manganese sulfate (manganese), manganese oxide (manganese), zinc carbonate (zinc), zinc oxide (zinc).

Vitamins: Vitamins most commonly function as coenzymes and regulators of metabolism. Source: Yeasts, fish solubles, distillers' solubles, liver meal, alfalfa meal, milk by-products.

Feed additives: Additives are rarely nutrients. They either singly or in combinations are added to a basic feed, usually in small qualities for the purpose of fortifying these with certain nutrients or stimulants or medicines. Often they are called “non-nutrient” feed additives. Some additives that promote feed intake or selection include antioxidants like BHT (Butylated hydroxytoluene), Santoquin, Ethoxyquin, BHA (Butylated hydroxyanisode), and DPPD (Diphenyl paraphenyl diamine. Pellet binders include Sodium Bentonite (clay), liquid or solid by-products of the wood pulp industry, molasses, and guarmeal. Additives that enhance the color or quality of the marketed product include Xanthophylls, synthetic carotinoid, and canthaxanthin. Chelates include EDTA. Enzymes include Agrozyme, Diazyme, Zymopabst, Prozyme and Avizyme. Probiotics are typically strains of lactobacillus and streptococcus. Antibiotics include penicillin, streptomycin, tetracyclines, and aureomycin.

Additives that alter metabolism include hormones such as Progesterone and Dienestrol diacetate. Additives that affect health status include antifungal additives like Aflatoxin by Asperfillus flavus, sodium propionate, sodium benzoate, and quaternary ammonium compounds, commercial anticoccidials such as Bifuran supplement, Ampro125%, Embazin, Zonamix, Nitrofurazone, and Furazolidone, and antihelmintic drugs.

Presently there is concern that the overuse of antibiotics and other antimicrobials may diminish their effectiveness for human health. Organic feeds, such as Countryside Natural Products Organic Soy-Free Poultry Layer Feed (Crude protein, minimum: 15.00% Crude fat, minimum: 2.00% Crude fiber, maximum: 7.00%) contains Organic Field Peas, Organic Wheat, Organic Corn, Organic Oats, Calcium Carbonate, Hydrated Sodium Calcium Aluminosilicate, Organic Flaxseed, Organic Alfalfa Meal, Fish Meal, Dried Organic Kelp, Dicalcium Phosphate, Salt, Sodium Selenite, Vitamin A Supplement, Vitamin D3 Supplement, Vitamin E Supplement, Choline, Menadione Sodium Bisulfite Complex, d-Pantothenic Acid, Niacin, Riboflavin, Pyridoxine Hydrochloride, Thiamine, Vitamin B12 Supplement, Biotin, Folic Acid, Iron Polysaccharide Complex, Manganese Polysaccharide Complex, Zinc Polysaccharide Complex, Copper Polysaccharide Complex, Cobalt Polysaccharide Complex, Yeast Culture, Dried Lactobacillus Acidophilus Fermentation Product, Bacillus Licheniformis, Bacillus Subtilis, Lactobacillus Lactis, Enterococcus Faecium, (Dried Aspergillis Oryzae Fermentation Extract), are available, but expensive and animals are at greater risk of infection than those that get conventional poultry feed.

It is therefore an object of the present invention to provide feed additives to increase egg yields and/or weight gain.

It is a further object of the present invention to provide feed additives to improve or maintain the health of chickens without antibiotics.

### SUMMARY OF THE INVENTION

An animal feed product is based on a combination of four natural ingredients, propolis, ginger root, colostrums, and L-lysine, each of which has properties either effective against specific pathogens or which is known to be an immune system stimulant/enhancer. These components are currently in use individually in many animal and human health-related products. The initial formulations used in preliminary research described in the example used equal parts by weight of prepared, powdered ingredients. Formulations can be modified as needed to fit the needs of different poultry product applications. The results of testing showed a statistically significant increase in egg yield.

### BRIEF DESCRIPTION OF THE DRAWINGS

FIG. 1 is a bar graph showing the body weight of broiler chicks at 21 days of age that were treated with 1, 2 and 4% PGL.^{a,b} Means within a column with differing superscripts are statistically different (P≦0.05).

FIG. 2 is a bar graph showing the feed conversion of broiler chicks at 21 days of age that were treated with 1, 2 and 4% PGL.

FIG. 3 is a bar graph showing the spleen, thymus and bursa of Fabricius weights as a percent of body weight of birds treated with 1, 2, and 4% PGL. Weights taken at 14 days of age.^{a,b} Means within a column with differing superscripts are statistically different (P≦0.05).

FIG. 4 is a bar graph showing the total anti-SRBC antibody titer of broiler chicks fed PGL. Data represent the mean of log₂ of the reciprocal of the last dilution exhibiting exhibiting agglutination.

FIG. 5 is a bar graph showing the lymphoproliferative response to PHA-P injections into the wing web of broiler chicks.

### DETAILED DESCRIPTION OF THE INVENTION

A poultry feed additive has been developed which contains four components to provide an organic/natural means to provide poultry with protection from a wide variety of pathogens, including viruses of the Orthomyxoviridae family, causative agents of human and animal influenzas, most notably including avian influenza. The antibacterial properties of the additive should be effective to control psittacosis, a disease currently being closely monitored by the CDC due to its ability to infect commercial poultry flocks and humans. Additionally, the components of this additive are selected for their ability to provide an important level of immune system stimulation. The additives are combined with standard commercial feeds and fed to the poultry in the same fashion as feed in the absence of the additives.

The additive ingredients are:
1. Propolis: Propolis is a natural product collected by honey bees from natural plant sources, primarily conifers. It is used as a protective substance in their hives and has also been used by humans as a multi-use medicinal source for many years. It has been documented in many refereed research papers as having significant antiviral, antifungal, antibacterial, anti-tumor, anti-parasite properties as well as being anti-inflammatory and an immune system stimulator. Antiviral research with this component shows positive action against several virus types including the virus families that are the causal agents of both Newcastle Disease and Avian Influenza. It is also active against a wide range of bacterial pathogens, indicating it is effective against the rising threat posed by Psittacosis, a disease common in pet bird populations that is spreading to commercial poultry flocks. In addition, research indicates it is effective against Giardia duodenalis and Giardia lamblia trophozoites, intestinal parasites with similar pathogenicity to Coccidiosis, a major disease problem in poultry. See, for example, Kujumgiev, et al. 1999. Antibacterial, antifungal and antiviral activity of propolis of different geographical origin. J. Ethnopharnacol. 64(3):235-40; and Serkedjieva, et al. 1992; Anti-influenza virus effect of some propolis constituents and their analogues (esters of substituted cinnamic acids. J. Nat Prod. 55(3):294-302; Huleihel M. and Isanu V. 2002. Anti-herpes simplex virus effect of an aqueous extract of Propolis. Isr. Med. Assoc. J. d(11Suppl). 923-7; Abd E l Hady F K and Hegazi A G. 2002. 2. Chemical composition, antiviral and antimicrobial activities of East Nile Delta propolis. Z. Naturforsch (C) 57 (3-4):386-94; Russo A. Longo R. and Vanella A. 2002. Antioxidant activity of propolis: role of caffeic acid phenethyl ester and galangin. Fitoterapia. 2002 November; 73 Suppl 1:S21-9; Fernandes et al. 2007. The “in vitro” antifungal activity evaluation of propolis G12 ethanol extract on Cryptococcus neoformans. Rev Inst Med Trop Sao Paulo. 49(2):93-5; et al. 2007. Antibacterial and free-radical scavenging activities of Sonoran Propolis. J. Appl. Micrbiol. 103(5): 1747-56; Higashi K O. de Castro S L. 1994. Propolis eztract are effective against Trypanosoma cruzi and have an impact on its interaction with host cells. J. Ethnopharmacol. 43(2):149-55.

A preferred product is powdered Brazilian Green. Similar benefits and anti-microbial properties of propolis from many other geographical sources are well documented. Powdered propolis is initially added at a one to one ratio with the other three components to equal the most common reported industry standard for powdered additives of one pound per ton of feed. This is subject to adjustment to fit individual application needs.

Ginger root: Ginger root is a popular natural substance, noted for immune system stimulating activity and widely used in human organic/natural preparations. It has also been the subject of published human and animal nutrition research. Fahey et al. 2002. Pinostrobin from honey and Thai ginger (Boesenbergia pandurata): a potent flavonoid inducer of mammalian phase 2 chemoprotective and antioxidant enzymes. J. Agric. Chem. 50(25); 7472-6; Wang H. Ng T B. 2005. An antifungal protein from ginger rhizomes. Biochem Biophys Res Commun. 336(1):100-4; Ajith, et al 2007. Zingiber officianale Roscoe prevents acetaminophen-induced acute hepatotoxicity by enhancing hepatic antioxidant status. Food Chem. Toxicol. 45(11):2267-72. Ginger root is widely available from grocery stores and natural food stores. As used herein, ginger root includes ginger root, ground ginger root, and extracts and powders thereof. This is added in the same amounts as propolis, in a 1:1 ratio with the other additives, to a preferred total of one pound per ton of feed.

Colostrums: Colostrum is a thin yellowish fluid secreted by the mammary glands at the time of parturition that is rich in antibodies and minerals, and precedes the production of true milk. Colostrums, particularly bovine colostrums, is widely recognized for its importance in immune system activity. See, for example, Przybyiska, et al. Reprod. Domest. Anim. 42(4):402-9; Struff W G. Sprotte G. 2007 Bovine colostrum as a biologic in clinical medicine: a review. Part I: biotechnological standards, pharmacodynamic and pharmacokinetic characteristics and principles of treatment. Int J Clin Pharmacol Ther. 2007 April; 45(4):193-202; Zimecki M. Artym J. 2005. Therapeutic properties of proteins and peptides from colostrum and milk. Postepy Hig Med Dosw (Online). 59:309-23

The major bioactives in colostrums are: Immunoglobulin G (IgG) are the most abundant of the antibodies, normally comprising about 75% to 80% of all the antibodies in the body. They are found in all body fluids as well as in blood serum and lymph. IgG antibodies, considered the most important for fighting bacterial and viral infections, have an exceptionally high presence in first milking colostrums. Lactoferrin is a protein found in milk, tears, mucus, bile, some white blood cells and colostrums. It is currently being studied for the treatment and prevention of cancer. Lactoferrin has already been proven to assist with fighting infection and inflammation, as well as having antioxidant effects. Insulin-like Growth Factor 1 is a crucial blood protein produced in the liver in response to stimulation by growth hormone. IGF-1 provides the best indicator of growth hormone levels. Optimal levels are linked to healthy bone, heart, thyroid, skin and nervous system. Thymosin is one of several polypeptide hormones secreted by the thymus that controls the maturation of T cells.

Colostrums are available in powdered form from feed stores, animal health supply stores, and from local dairy farms. Much of the published research relates to use of this in animal feeds and its value to important health aspects of various livestock. Colostrum is added in the same concentrations as propolis and ginger root, again subject to adjustments to application needs.

L-Lysine: L-lysine is an essential amino acid. The value of lysine in animal feed diets has prompted much research to develop crops having high lysine. The success with corn is well known and animal feed diets using high-lysine corn have been widely used. Specific addition of lysine to animal diets has been researched to determine the optimum concentration for best efficiency. See for example, Corzo et al. 2003. Lysine needs of summer-reared male broilers from six to eight weeks of age. Poult. Sci. 82:1602-7; Augspurger NR. Baker D H. 2007. Excess dietary lysine increases growth of chicks fed niacin-deficient diets, but dietary quinolinic acid has no niacin-sparing activity. Poult Sci 86(2):349-55. Erratum in: Poult Sci. 2007 April; 86(4):790. Lesser attention has been placed on immune system responses. Added feed efficiency and weight gain are likely to be related to better immune responses. L-Lysine is added in the same concentration as propolis, ginger root and colostrums, again subject to the same adjustments as needed to fit the specific application.

In the preferred embodiment, the components are used in powdered form, added based on industry standards to determine the proper amount per ton of feed. Powdered, mixed components can be added to standard starter, grower, broiler or laying feed mixes. An initial mix using 100 g of each ingredient/ton of feed was used in the first feeding trials with a small local laying flock comparing performance, feed preference, egg laying and taste tests . All observations were positive and there were no bad tastes in the eggs. The amount of additive used, 10 grams of each component to 50 pounds of feed, is preferably based on standard industry ratios for powdered feed additives, 453 grams (one pound) per ton of feed. However the amount added can range from 1 to 100 grams of each component to 50 pounds of feed, or about 45 grams to 4,530 grams per ton of feed for the mixture of four components. In the preferred embodiment, each ingredient is added at a ratio of one to one to one to one. However, those skilled in the art would recognize that the actual ratio can range from 0.1 to 10, more preferably 0+5 to 5, still more preferably 1:1, of any of the four ingredients to any of the other ingredients with in the feed additive composition.

The effective amounts can be determined using known procedures for determining weight gain, egg yield (as described in example 1), or immune response. The following are representative procedures for measuring immune response:

Antibody Response

In order to measure antibody response, animals, such as chicks from each treatment group, can be immunized intravenously with sheep red blood cells (SRBC. Animals are bled 4, 7, 10 and 14 days post-injection and corresponding sera tested for total antibody and IgG and IgM levels.

Cell-Mediated Immune Response

A measure of T-cell mediated response can be determined by injecting phytohemagglutinin-P (PHA-P) intradermally in the right toe web of chicks. A saline control can be injected into the left toe web of each bird. Swelling in the left and right toe webs is measured with a constant tension caliper 24, 48 and 72 hours post-injection.

Alternatively a method of using growing feathers as an in vivo method of measuring cell mediated immunity can be used. Feathers are injected with PHA-P and heterophil, macrophage, and lymphocyte infiltration histologically examined.

Lymphoid Organ Development

The bursa Fabricius and spleen can be removed from birds from each treatment group at a predetermined age such as 14 days of age and weighed. Organ weights are expressed as a percentage of body weight for comparison purposes.

All data are examined by Analysis of Variance. Comparisons among treatments can be determined by appropriate multiple comparison procedures.

The present invention will be further understood by reference to the following non-limiting examples.

### Example 1

### Feeding and Taste Test Results on Small Flock Laying Hens

Introduction

The poultry feed additive, which features equal amounts of the selected, natural ingredients, was tested using a small local laying flock for a twelve-day feeding/egg taste trial. The major objective was to observe the feeding behavior of the hens to determine if any feeding differences were related to the additive and if any of the components imparted detectable or objectionable tastes to the eggs.

Procedures

Twenty Buff Orppington hens were separated into two groups of ten each. Group One was fed a standard laying mix. Group Two was fed the same laying mix with the additive, consisting of equal amounts of Propolis, ground ginger root, colostrums and L-Lysine. The amount of additive used, 10 grams of each component to 50 pounds of feed, was based on standard industry ratios for powdered feed additives, 453 grams per ton of feed.

During the twelve-day test, the general feeding behavior of the two groups was observed to determine if any avoidance was noted. Egg numbers were counted, marked and tested for taste differences.

Results and Discussion

No observable differences in feeding behavior were recorded and each group consumed feed at pretest rates. There was no evident avoidance of the feed by either test group offering preliminary evidence that the additive posed no acceptance problem.

Taste tests were conducted daily, comparing eggs from each group. No differences were noted between groups. The twelve-day test provided adequate time for any taste changes to be detectable.

Egg production by the entire flock had been at its normal late fall reduced numbers at the beginning of the test. There were no differences in egg numbers during the first part of the test, (Table 1). By day six, Group Two had a slight increase in numbers. The total egg production by Group Two, 80 versus the 70 eggs from Group One, is statistically significant, evidence of an important benefit derived from the additive.

Paired Student's t-Test: Results
The results of a paired t-test performed where t=−2.28
degrees of freedom=11

The probability of this result, assuming the null hypothesis, is 0.044, indicating that it is statistically significant.

TABLE 1
Effect of a Natural Poultry Feed Additive on Egg Production

| Day Number | Group One | Group Two |
|---|---|---|
| 1 | 6 | 5 |
| 2 | 7 | 6 |
| 3 | 5 | 6 |
| 4 | 5 | 6 |
| 5 | 6 | 5 |
| 6 | 5 | 7 |
| 7 | 6 | 7 |
| 8 | 5 | 8 |
| 9 | 6 | 7 |
| 10 | 7 | 8 |
| 11 | 6 | 8 |
| 12 | 6 | 7 |
| Total | 70 | 80 |

### Example 2

### Immune Response of Broilers to a Dietary Supplement of Propolis, Ginger Root and Lysine

A feed additive composition (“PGL”), containing propolis, ginger root and lysine and colostrums, was tested by the University of Georgia Poultry Science Department on broiler chicks to determine whether it had an effect on growth, feed efficiency and immune system function.

Materials and Methods

Three hundred broiler chicks were obtained from a commercial hatchery. Chicks were housed in a Petersime chick battery and reared under appropriate brooding conditions. Feed and water were provided ad libitum. Light was provided 24 hours per day. The chicks were randomly assigned to 12 groups of 20 chicks each. These 12 groups were subdivided into four treatment groups (three groups per treatment). Four treatment diets were fed: control diet (C), control diet +1% PGL (1% PGL), control diet +2% PGL (2% PGL), control diet +4% PGL (4% PGL). The control diet was a corn/soy based broiler starter diet similar to that used by the U.S. broiler industry.

Body Weight, Feed Conversion and Lymphoid Organ Weights

At 14 days of age, 12 birds from each treatment were euthanized and weighed. The thymus, spleen and bursa of Fabricius were removed from these birds and weighed. The organ weights were expressed as a percentage of body weight. At 21 days of age, all birds were weighed and feed conversions were calculated.

Antibody Response

At seven days of age, 12 chicks from each treatment group were injected intravenously with 1 ml of 0.5% sheep red blood cells (SRBC) suspended in phosphate buffered saline (PBS). The SRBC served as a T lymphocyte-dependent antigenic challenge to allow quantification of an antibody response. A serum sample was collected from each chick at 14 days of age (seven days post injection) and serially diluted (log₂) into 8 wells of a microtiter plate. A 2% suspension of SRBC was added to the diluted serum samples and the microtiter plate was incubated at 37 C for 6 hours. The antibody titer for a serum sample was considered to be the serum dilution that preceded a well containing a distinct SRBC button.

Lymphoproliferative Response to PHA-P

At 18 days of age, the lymphoproliferative response to Phytohemagglutinin-P (PHA-P), an indicator of T-cell-induced delayed hypersensitivity reaction, was assessed by injecting intradermally 0.1 ml of 1 mg/mL PHA-P into the right wing web of 12 chicks in each treatment. For comparison purposes, an equal amount of PBS was injected into the left wing web of each chick. The thickness of each wing web was then measured at 24 and 48 hours with a micrometer. A negative control was included to validate this immunological assay. Two birds in each pen were injected with dexamethasone (DEX, 1.5 mg/kg body weight), an established immunosupressor. Birds injected with DEX exhibited no wing web swelling, confirming that the observed swelling among treatments likely represented a true immunological response.

Results

Body Weight, Feed Conversion and Lymphoid Organ Weights

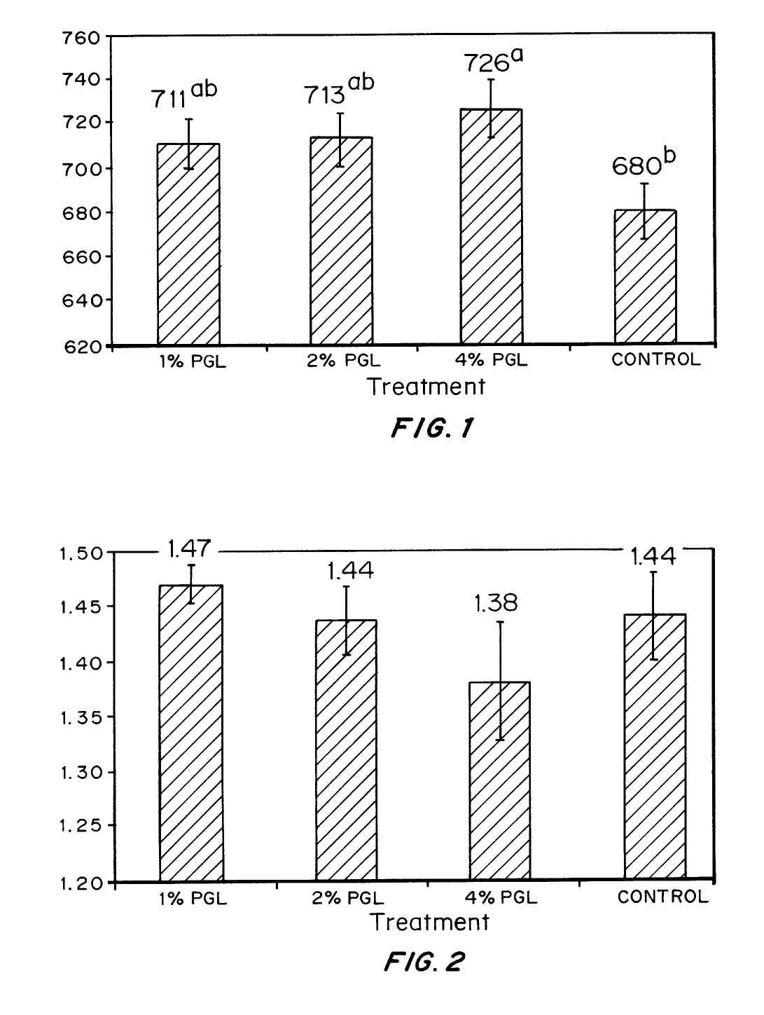

At 21 days of age, all birds were weighed and feed conversions (feed consumed/body weight) were calculated. FIG. 1 provides average body weight and FIG. 2 provides average feed conversion for each treatment. Body weight of the 4% PGL treated birds was significantly greater than the control.

FIG. 1 shows the body weight of broiler chicks at 21 days of age that were treated with 1, 2 and 4% PGL. FIG. 2 shows the feed conversion of broiler chicks at 21 days of age that were treated with 1, 2 and 4% PGL.

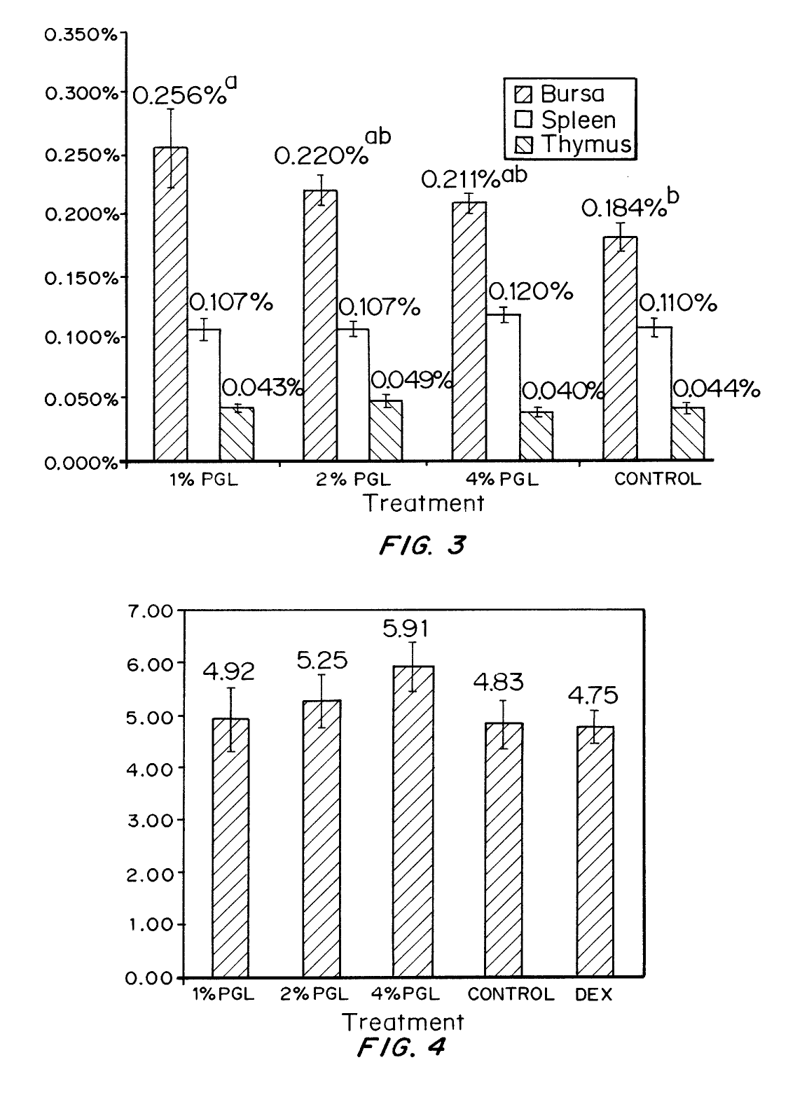

At 14 days of age lymphoid organ weights were taken from a sampling of chicks. FIG. 3 is a chart of the spleen, thymus and bursa of Fabricius weights as a percent of body weight of birds treated with 1, 2, and 4% PGL. Weights were taken at 14 days of age. These organ weights are expressed as a percent of the chick weight as shown in FIG. 3. An increase in size of lymphoid organs would suggest that the immune system may have been stimulated. Although there were no statistically significant differences in thymus or spleen weights between PGL treated birds and controls, the bursa weights of the 1% PGL treated birds was significantly heavier than the controls.

Antibody Response to SRBC

The antibody response of 7 day-old broilers to SRBC is shown in FIG. 4, showing total anti-SRBC antibody titer of broiler chicks fed PGL. Data represent the mean of log₂ of the reciprocal of the last dilution exhibiting agglutination. An increase in antibody titers to SRBC would suggest an enhanced immune system response. There were no statistically significant differences among treatments. A non significant numerical trend was observed; but again, none of the PGL treatments or the DEX treatment was found to be statistically different from the control.

Lymphoproliferative Response to PHA-P

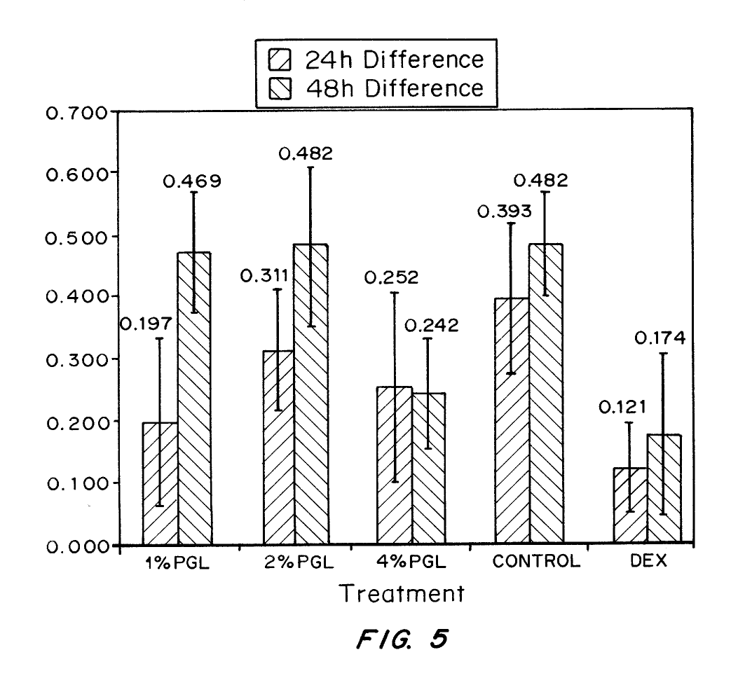

Phytohemagglutinin-P (PHA-P) is a T-cell mitogen which enhances T-lymphocyte proliferation. Injection of PHA-P in the wing web of chicks induces a localized in vivo proliferation of T-lymphocytes and is an indicator of T-cell induced delayed type hypersensitivity reaction. This response was measured at 24 and 48 hours post PHA-P wing web injection. These results are reported in FIG. 5. An increased swelling of the wing web would indicate a heightened immune response. The PGL treatments had no consistent effect on the PHA-P response, while the DEX treatment produced an expected immunosuppressive response.

DISCUSSION

Immune Function Measurements

All of the PGL treatments appeared to impact the relative weight of the bursa. In the chicken, the bursa is a critical immune organ responsible for the production of B-cells. It is generally assumed that an increase in bursal weight correlates with enhanced immune function. The increase observed in bursa weight in the 1% PGL treated birds provides some indication that PGL is impacting the immune system. A statistically significant increase in 2% PGL and 4% PGL treated birds was not observed.

SRBC injections are a classic method of simulating a disease challenge (exposure to a foreign antigen). In the present experiment, there were no differences in PGL treated birds compared to controls at the P>0.05 level of significance. The PHA-P injections into the wing web did not appear to impact the immune system as measured by swelling. Wing web thickness measurements were statistically similar in PGL treated and control broilers; however, the DEX treatment suppressed the swelling response, as expected. It was noteworthy in this experiment that there were some indications that PGL treatments affected the immune system relative to increasing bursal weight. The research laboratory conditions under which the research birds were raised in the present experiment are highly controlled to reduce variation; however, they do not simulate industry conditions where birds may be challenged by environmental conditions and exposure to multiple disease pathogens. Although both the SRBC and PHA-P injections simulate disease challenges by triggering an immune response, this experimental challenge may not necessarily reflect the immunological demands that commercial broilers would routinely face.

Growth and Feed Conversion

A clear increase in growth was observed in the experiment. The PGL treated birds were significantly heavier at 3 weeks of age compared to the controls. It appeared that the increase in growth rate may have been dose dependent. The 1%, 2% and 4% PGL treated birds were 30, 35 and 49 g heavier respectively than controls at 3 weeks. Feed conversion of the 4% PGL group was significantly better than the control.

Modifications and variation of the compositions and methods of manufacture and use thereof will be obvious to those skilled in the art from the foregoing detailed description and are intended to come within the scope of the following claims.

What is claimed is:

1. A feed additive composition comprising:
Propolis, L-lysine, colostrums, and ginger root.

2. The feed additive of claim 1 wherein the additives are in a ratio to each other of 0.1 to 10, 0.5 to 5, or 1:1, of each of the ingredients to each other.

3. The feed additive of claim 1 wherein the feed composition contains no antibiotics.

4. The feed additive of claim 1 wherein the feed composition is certified organic.

5. An animal feed composition comprising Propolis, L-lysine, colostrums, and ginger root, in an effective amount to increase weight gain, egg yield, or disease resistance.

6. The animal feed composition of claim 5 wherein the additives are in a ratio to each other of 0.1 to 10, 0.5 to 5, or 1:1, of each of the ingredients to each other.

7. The animal feed of claim 5 wherein the additives are added to the feed in an amount between about 45 grams to 4,530 grams per ton of feed for the mixture of four components, preferably 453 grams per ton of feed

8. The animal feed of claim 5 wherein the feed composition contains no antibiotics.

9. The animal feed of claim 5 wherein the feed composition is certified organic.

10. A method of feeding animals to increase weight gain, egg yield or disease resistance comprising providing to the animals an effective amount of the feed additive of any of claims 1-5 or the feed composition of any of claims 5-9.
